(19) United States
(12) Patent Application Publication
(10) Pub. No.: US 2022/0207560 A1
(43) Pub. Date: Jun. 30, 2022

(54) DIRECTED MARKETING SYSTEM AND APPARATUS

(71) Applicant: 7-ELEVEN, INC., Irving, TX (US)

(72) Inventor: Justin J. Nguyen, Houston, TX (US)

(73) Assignee: 7-ELEVEN, INC., Irving, TX (US)

(21) Appl. No.: 17/696,047

(22) Filed: Mar. 16, 2022

(51) Int. Cl. G06Q 30/02

(52) U.S. Cl. CPC G06Q 30/0253; G06Q 30/0206; G06Q 30/0201

(57) ABSTRACT

A system and method for directed marketing that allows the user to designate desired parameters and analyze data to increase sales on an individual store level. The directed marketing system features machine learning to optimize sales.

### BACKGROUND AND PRIOR ART

Customers often make a purchasing decision in-store, often called an impulse purchase, or unplanned purchase. A customer enters a store to make a planned purchase, but during the trip something in the store entices the customer to make an impulse purchase. It has been reported that over 87% of U.S. shoppers make impulse purchases and that more than 50% of all grocery is sold because of impulsiveness. Convenience stores will often use marketing in the store to help drive these impulse purchases. But, a static advertisement might not be beneficial all hours of the day for a variety of reasons. For example, an advertisement for coffee is much less effective at 8 pm, than it is at 8 am. Further, several other variables can impact impulse sales, including, but not limited to, weather, season, time of day, geographic location, regional demographics, age distribution, and the number of loyalty customers. Therefore, it would be beneficial if in-store marketing could be custom tailored to the variables of a specific store, at desired times. Thus, allowing the store to increase impulse sales.

### SUMMARY OF THE INVENTION

These systems and methods are designed and optimized to provide media and digital assets (ex. video, audio) to in-store customers to drive increased basket size and additional purchases.

The overall system comprises of four main components: 1) customer-facing store with digital advertising installed on-premise, 2) integration engine that gathers, retrieves, stores, and aggregates key data from multiple and various data sources that are necessary for analysis, 3) a digital asset repository that stores and returns various digital media such as images, video, and audio files, and 4) an artificial intelligence (AI) engine that analyzes all data inputs, leverages vector optimizations and methods, and calculates and determines in-store digital marketing strategies.

The advantage and application for these systems and methods are to fine-tune and optimize in-store marketing media for retail. Based on temporal, geospatial, sales, inventory, and other information, this system will analyze and return the most optimal digital media to expose to active customers who are on-premises. Each algorithm is tuned to a specific store location and optimizes specific times of day to boost sales. Store data like recent transactions, inventories, etc. are merged with store attribution like geospatial and temporal features to rank and push the most promising digital assets at the most optimal time periods.

The customer-facing store comprises of a consumer environment that sells goods. It must also contain a vehicle for digital advertising, such as a TV, handheld smart device, a smart display device, or speaker, that is connected and integrated to the other components in this system.

The integration engine consists of data compute and storage resources that are able to parse, aggregate, and flatten inputs for downstream analysis.

The integration engine is connected to 1) customer-facing store having transaction and inventory data, 2) a digital asset repository where capable of requesting and accepting digital media, and 3) an AI engine that receives aggregated data and outputs from all data sources for deeper analysis and computation.

The digital asset repository is an online file repository that stores digital media files to be used for advertising. It may or may not also contain tags and metadata for each digital media file. It consists of an endpoint that can receive requests for specific types of digital media files based on specific attribution. The endpoint can also return responses, where the response contains a matching digital media file. An example is an advertisement and picture for a coffee or pizza.

The AI system is fine-tuned for big data analysis and a large range of parameters and file formats. Parameters can include temporal, geospatial, and POS attribution and data which can be tabular or non-structured. This also includes digital file formats such as jpg, png, tiff, way, mp4, etc. The AI engine consists of several novel components and methods, including 1) an encoder that can vectorize digital media files, 2) matrix functions that can perform transformations such as concatenation, decompositions, convolutions, and other operations, 3) at least one machine learning algorithm that can analyze and perform computation on vector inputs, 4) config files that enable specific parameters of the AI engine to be tuned and controlled, 5) an application log and database that tracks and stores historical activity, and 6) an output of recommended transactions for advertising including the digital media file, attribution, model parameters and explanation, and model-produced score or ranking. This output is consumed by the customer-facing store for advertising.

The directed marketing system is designed to collected and aggregate inventory and sales data, along with seasonal attributes like weather, temperature, season, and time of day, and geospatial attributes such as the local demographics, traffic, market trends, and population density.

### IN THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a directed marketing system utilizing digital content, according to an embodiment of the present disclosure.

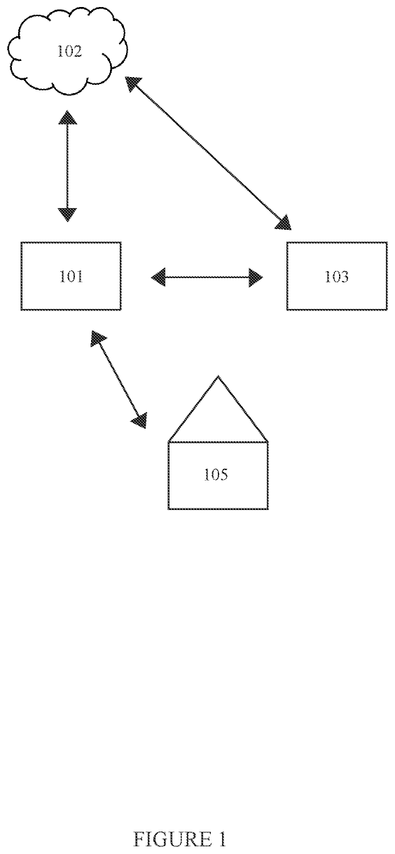

FIG. 2 is a block diagram of a digital content directed marketing system in accordance with an embodiment of the present disclosure.

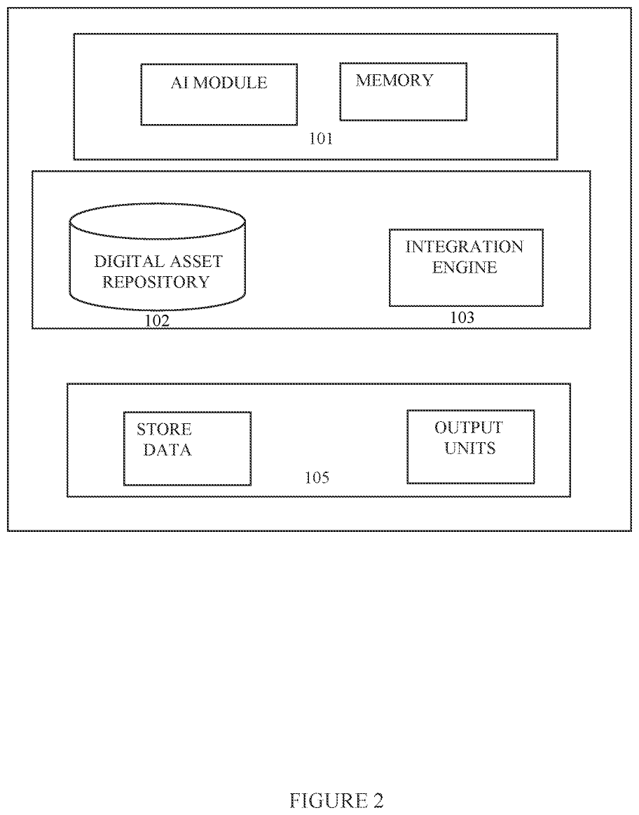

FIG. 3 is a flow diagram illustrating a method for implementation of the proposed system in accordance with an embodiment of the present disclosure.

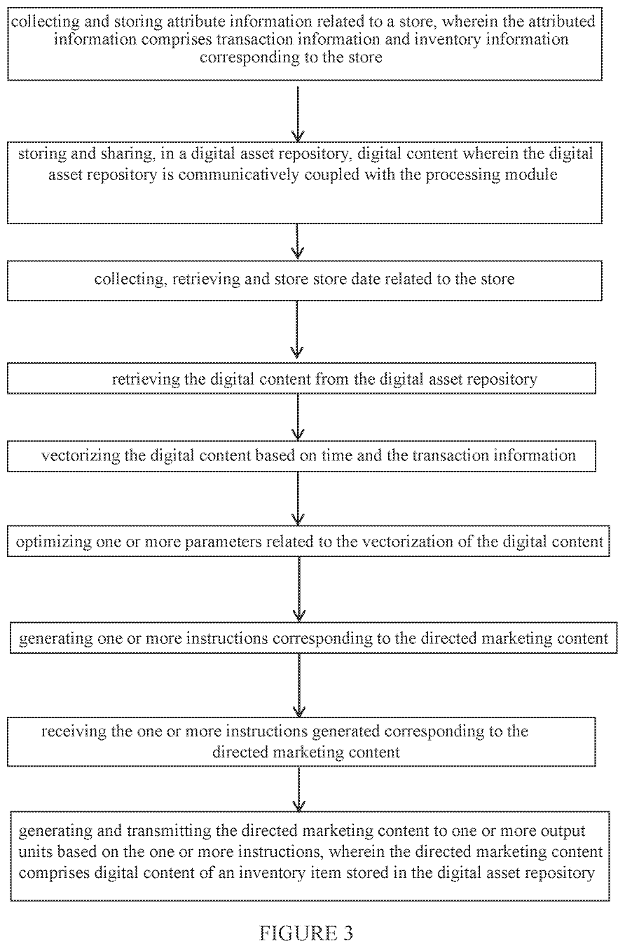

### DETAILED DESCRIPTION

A system and apparatus designed to direct marketing to a specific consumer base that varies by store location. The present invention is directed to a marketing system and apparatus 100 that utilizes machine learning to increase sales. In the preferred embodiment, the system comprises a local machine learning CPU or artificial intelligence 101, a digital asset repository in communication with an encoder 102, an integration engine 103, and at least one local display at a store 105.

The local machine learning CPU is in communication with a centralized digital asset repository having an integration engine. The local machine learning CPU, or artificial intelligence, utilizes vector optimization and rank based method to improve sales by analyzing and displaying the optimal digital asset based on a predetermined set of parameters. The integration engine gathers, retrieves, stores, and aggregates key data from multiple and various data sources that are necessary for analysis. The digital asset repository is a centralized storage of all digital advertisements, including but not limited to images, videos, and audio files. The local digital display is a customer facing display capable of displaying the desired digital media and may include speakers or a touch screen.

The local central processing unit is capable of analyzing desired parameters, calculating the digital media asset most likely to increase desired sales, and requesting specific digital marketing items housed in the digital asset repository. The digital asset repository being ever changing and vast, requires an encoder to communicate with the local machine learning CPU to determine and locate the requested digital marketing asset. The encoder, by vectorizing digital media files, is capable of searching the digital asset repository for the requested digital asset and then relaying the requested digital asset back to the local machine learning CPU. The local machine learning CPU, also being in communication with at least one local digital display, then communicates the desired digital asset to the digital display to increase sales of the desired item.

The local machine learning CPU, by utilizing and weighting desired parameters and store specific data points, is programmed to build a training model based on said parameters and data, to predict and make decisions without the need for a user input. This is beneficial, particularly for companies that have many locations. Programming and monitoring each individual store on a daily basis would be untenable. Programming and monitoring each individual store on a on a minute-by-minute basis, as is proposed herein, could not be accomplished by a user due to time constraints.

In the preferred embodiment, the directed marking system, will analyze the designated parameters, compare the parameters to known store data (for example; inventory and transaction history) to determine the best possible advertisement to display locally. The integration engine aggregates the desired data and communicates said data with the local machine learning CPU. The local machine learning CPU, based on the training algorithm, analyzes all data points including the aggregated data from the integration engine and the predetermined parameters to select a desired digital media to display. The local machine learning CPU then relays a request for a specific digital asset to the digital repository, the encoder reads the request and searches the digital repository for the desired digital asset and relays the advertisement back to the local machine learning CPU which in turn displays the desired digital asset on a local display. This process can be adjusted to occur as often as desired, however, it is envisioned that it would occur minute-by-minute to optimize impulse sales. Note that the digital asset may not be changed minute to minute, but the calculation is still being performed to determine if the current digital asset is best to increase sales.

There being a desire to control the learning of the local machine learning CPU, the local machine learning CPU will analyze and adjust the training model to improve performance. In the preferred embodiment, the local machine learning CPU will review the training model once per day, but the review could happen more or less often as desired. Thus learning from previous performance and adjusting the directed marketing accordingly. The learning of the local CPU can be adjusted by controlling hyperparameters by adjusting the weights of the different variables. For example, one store may weight the weather heavily and prioritize coffee during colder temperatures and prioritize cold beverages during warm temperatures. In another store, the local machine learning CPU may weight excess inventory, like fresh food which has a low shelf life.

The local machine learning CPU will be permitted some amount of experimentation with the directed marketing to better learn what works best in a specific store. However, the local machine learning CPU will be restricted in this experimentation so that the system is not displaying an advertisement when it is not desired.

The directed marketing system can be tailored to each individual location without being unduly burdensome on the user. As the directed marketing system learns more about a specific location, the advertising will improve and therefore the stores sales will improve as well. Conversely, directed marketing system can learn from poor performance as well and adjust advertising accordingly.

In an alternative embodiment, the directed marketing system is used for broadcasting content in real time.

In yet another alternative embodiment, the directed marketing system could be programmed to identify the unique IP addresses of customers. The directed marketing system is configured to monitor the activity of the store during the time that the unique IP address is present. In future visits, the directed marketing system can then process the unique IP address and associated past activities to calculate and display advertainments targeted specifically to the customer based on the unique IP address.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claim.

I claim:

1. A system of directed marking comprising:
a machine learning central processing unit;
a centrally located digital asset repository in communication with an encoder;
at least one local display unit;
an integration engine, and;
wherein the integration engine aggregated desired data and communicated the aggregated data to the machine learning central processing unit which calculates and optimizes digital media, requesting said digital media from the centrally located digital asset repository, which, utilizing the encoder locates and returns the desired digital media, and displays the digital media on the at least one local display unit.

2. The system of claim 1 wherein the directing marketing is optimized to an individual store.

3. The system of claim 2 wherein the machine learning central processing unit is programmed to analyze desired parameters and select a digital media asset to increase sales.

4. The system of claim 3 wherein the machine learning central processing unit is programmed to continually, in real-time, analyze the desired parameters and update the digital media asset as often as is needed to increase sales.

5. A method of improving sales;
analyzing parameters and data in real-time;
calculating the desired media asset to increase sales in real-time;
retrieving the desired media asset from a digital media asset repository; and
displaying the desired media asset.

6. The method of claim 5 further including changing the desired media asset in real-time as the calculation changes to improve sales.

7. The method of claim 6 further including adjusting the parameters based on the previous days sales data.

8. A system of directed marketing comprising:
a machine learning central processing unit;
a digital asset repository;
an encoder;
an integration engine;
at least one display unit, and;
wherein the machine learning central processing unit is programmed with a set of parameters.

9. The system of claim 8 wherein the integration engine aggregates a store's inventory and sales data, weather, temperature, season, time of day, demographics, traffic, market trends and population density.

10. The system of claim 9 wherein the machine learning central processing unit, using the data aggregated from the integration engine, analyzes the data and the parameters and calculates which media asset would improve desired sales.

11. The system of claim 10 wherein the machine learning central processing unit requests the digital medial asset from the encoder.

12. The system of claim 11 wherein the encoder receives the request for the digital medial asset and searches the digital medial asset for a matching digital media asset.

13. The system of claim 12 wherein the encoder locates the digital medial asset and relays said asset to the machine learning central processing unit.

14. The system of claim 12 wherein the machine learning central processing unit receives the digital medial asset and displays it on the at least one display.

15. A system for broadcasting content in real time, the system comprising:
an information management module for collecting and storing attribute information related to an entity, wherein the attribute information comprises transaction information and inventory information corresponding to the entity;
a digital asset repository configured to store and share digital content of an inventory of the entity;
an integration engine comprising one or more memory units and one or more processing units communicatively coupled with the information management module and the digital asset repository, the integration engine configured to:
collect, retrieve, aggregate, store, and transmit data related to the entity from the information management module; and
retrieve the digital content from the digital asset repository;
an artificial intelligence engine comprising one or more memory units and one or more processing units communicatively coupled with the integration engine, wherein the artificial intelligence engine is configured to:
vectorize the digital content based on its size, features, and content,
optimize one or more parameters related to the vectorization of the digital content,
compare and analyze inventor and sales data, seasonal attributes and geospatial attributes, and
generate one or more instructions corresponding to the broadcasting content; and
a broadcast unit configured to:
receiving the one or more instructions generated by the artificial intelligence engine corresponding to the broadcasting content; and
generating and transmitting the broadcasting content to one or more output units based on the one or more instructions, wherein the broadcasting content comprises digital content of an inventory item stored in the digital asset repository.

16. The system of claim 15, wherein the information management module comprises one or more data collections methods for tracking and collecting the attributes information such as sales.

17. The system as claimed in claim 15, wherein the digital content comprises audio files, video files or image files.

18. The system of claim 15, wherein the one or more output units is selected from a group comprising of a television, a speaker, a handheld smart device, or a smart display device.
